(19) United States
(12) Patent Application Publication
(10) Pub. No.: US 2026/0237356 A1
(43) Pub. Date: Aug. 13, 2026

(54) DISPLAY DEVICE AND ELECTRONIC DEVICE HAVING SCAN DRIVER INCLUDING SCAN STAGES

(71) Applicant: SAMSUNG DISPLAY CO., LTD., YONGIN-SI (KR)

(72) Inventors: Jun Ki JEONG, Yongin-si (KR); Jun Hyun PARK, Yongin-si (KR); Hwa Rang LEE, Yongin-si (KR); Na Hyeon CHA, Yongin-si (KR)

(21) Appl. No.: 19/410,202

(22) Filed: Dec. 5, 2025

(30) Foreign Application Priority Data
Feb. 10, 2025 (KR) 10-2025-0016496

(51) Int. Cl. G09G 3/3266; G09G 3/20; G09G 3/3233

(52) U.S. Cl. CPC G09G 3/3266; G09G 3/2007; G09G 3/3233; G09G 2300/0426; G09G 2300/0842; G09G 2310/0286; G09G 2310/08

(57) ABSTRACT

A display device includes a pixel part including a plurality of pixel rows, each extending in a first direction and arranged in a second direction, and each connected to an odd-numbered scan line and an even-numbered scan line. A scan driver includes a plurality of scan stages, each connected to the odd-numbered scan line and the even-numbered scan line. Each of the scan stages includes buffer transistors. Buffer clock lines connected to the buffer transistors extend in the second direction between the buffer transistors and the pixel part.

### CROSS-REFERENCE TO RELATED APPLICATION

This application claims priority under 35 U.S.C. § 119(a) to Korean Patent Application No. 10-2025-0016496, filed on February 10, 2025, in the Korean Intellectual Property Office, the disclosure of which is incorporated by reference herein in its entirety.

### TECHNICAL FIELD

The present disclosure relates to a display device and, more specifically, to a display device and an electronic device that include a scan driver with scan stages.

### DISCUSSION OF RELATED ART

As information technology has developed, the importance of a display device, which is an important means for connecting a user to information, has been highlighted. Accordingly, the use of display devices such as a liquid crystal display (LCD) device, an organic light emitting diode (OLED) display device, and the like has been increasing.

The display device may include a plurality of pixels for displaying an image. The pixels may display the image by emitting light corresponding to an input data voltage.

A scan driver is used to select which data voltages to send to each pixel. A plurality of clock lines may be used to drive the scan driver. The longer the length of clock line, the greater the electrical load, which may increase the required power consumption.

### SUMMARY

A display device includes a pixel part in which pixel rows each extending in a first direction are arranged in a second direction, and each of the pixel rows is connected to an odd-numbered scan line and an even-numbered scan line. A scan driver includes scan stages, each connected to the odd-numbered scan line and the even-numbered scan line. Each of the scan stages includes buffer transistors. Buffer clock lines connected to the buffer transistors extend in the second direction between the buffer transistors and the pixel part.

Each of the of the scan stages may include a logic circuit. A first buffer transistor having a first electrode may be connected to an odd-numbered buffer clock line, a gate electrode may be connected to the logic circuit, and a second electrode may be connected to the odd-numbered scan line. A second buffer transistor having a first electrode may be connected to the odd-numbered scan line and a gate electrode may be connected to the logic circuit. A third buffer transistor having a first electrode may be connected to an even-numbered buffer clock line, a gate electrode may be connected to the logic circuit, and a second electrode may be connected to the even-numbered scan line. A fourth buffer transistor having a first electrode may be connected to the even-numbered scan line and a gate electrode may be connected to the logic circuit.

The first buffer transistor may be disposed on one side of the second buffer transistor in the first direction, and the third buffer transistor may be disposed on one side of the fourth buffer transistor, in the first direction.

The logic circuit may be disposed on one side of the first buffer transistor, the second buffer transistor, the third buffer transistor, and the fourth buffer transistor in a direction opposite to the first direction.

The logic circuit may be connected to a carry clock line, and the carry clock line may be disposed on one side of the logic circuit, in the direction opposite to the first direction and may extend in the second direction.

The logic circuit may be connected to a carry clock line, and the carry clock line may extend in the second direction between the first buffer transistor and the pixel part.

The third buffer transistor may be disposed on one side of the first buffer transistor, in the second direction, and the even-numbered scan line may be disposed on one side of the odd-numbered scan line.

The fourth buffer transistor may be disposed on one side of the second buffer transistor, in the second direction.

The first buffer transistor may be disposed on one side of the third buffer transistor in the second direction, and the odd-numbered scan line is disposed on one side of the even-numbered scan line, in the second direction.

The second buffer transistor may be disposed on one side of the fourth buffer transistor, in the second direction.

An electronic device includes a processor providing grayscales of an image frame. A display device displays an image using the grayscales. The display device includes a pixel part in which pixel rows each extending in a first direction are arranged in a second direction, and each of the pixel rows is connected to an odd-numbered scan line and an even-numbered scan line. A scan driver includes scan stages each connected to the odd-numbered scan line and the even-numbered scan line. Each of the scan stages includes buffer transistors. Buffer clock lines connected to the buffer transistors extend in the second direction between the buffer transistors and the pixel part.

Each of the scan stages may include a logic circuit. A first buffer transistor may have a first electrode connected to an odd-numbered buffer clock line, a gate electrode connected to the logic circuit, and a second electrode connected to the odd-numbered scan line. A second buffer transistor having a first electrode may be connected to the odd-numbered scan line and a gate electrode may be connected to the logic circuit. A third buffer transistor having a first electrode may be connected to an even-numbered buffer clock line, a gate electrode may be connected to the logic circuit, and a second electrode may be connected to the even-numbered scan line. A fourth buffer transistor having a first electrode may be connected to the even-numbered scan line and a gate electrode may be connected to the logic circuit.

The first buffer transistor may be disposed on one side of the second buffer transistor, in the first direction, and the third buffer transistor may be disposed on one side of the fourth buffer transistor, in the first direction.

The logic circuit may be disposed on one side of the first buffer transistor, the second buffer transistor, the third buffer transistor, and the fourth buffer transistor in a direction opposite to the first direction.

The logic circuit may be connected to a carry clock line, and the carry clock line may be disposed on one side of the logic circuit in the direction opposite to the first direction and may extend in the second direction.

The logic circuit may be connected to a carry clock line, and the carry clock line may extend in the second direction between the first buffer transistor and the pixel part.

The third buffer transistor may be disposed on one side of the first buffer transistor, in the second direction, and the even-numbered scan line may be disposed on one side of the odd-numbered scan line.

The fourth buffer transistor may be disposed on one side of the second buffer transistor, in the second direction.

The first buffer transistor may be disposed on one side of the third buffer transistor, in the second direction, and the odd-numbered scan line may be disposed on one side of the even-numbered scan line, in the second direction.

The second buffer transistor may be disposed on one side of the fourth buffer transistor, in the second direction.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a schematic diagram illustrating a display device according to an embodiment of the present disclosure.

FIG. 2 is a circuit diagram illustrating a pixel according to an embodiment of the present disclosure.

FIG. 3 is a schematic diagram illustrating a pixel part according to an embodiment of the present disclosure.

FIG. 4 is a schematic diagram illustrating a scan driver according to an embodiment of the present disclosure.

FIG. 5 is a circuit diagram illustrating a scan stage according to an embodiment of the present disclosure.

FIG. 6 is a waveform diagram illustrating a method of driving a scan stage according to an embodiment of the present disclosure.

FIG. 7 is a cross-sectional view of a display device according to an embodiment of the present disclosure.

FIGS. 8A, 8B, 9A, 9B, 10A, 10B, 11A, 11B, 12A, 12B, 13A, and 13B show plan view layouts of scan stages according to an embodiment of the present disclosure.

FIG. 14 is a schematic diagram illustrating a scan driver according to an embodiment of the present disclosure.

FIG. 15 is a schematic block diagram of an electronic device according to an embodiment.

FIGS. 16, 17, and 18 are perspective schematic diagrams of electronic devices according to various embodiments.

### DETAILED DESCRIPTION OF EMBODIMENTS

Hereinafter, embodiments of the present disclosure will be described in detail with reference to the attached drawings, such that those skilled in the art can easily implement the present disclosure. The present disclosure may be implemented in various forms, and is not necessarily limited to the embodiments to be described herein below.

The same or similar reference numerals may be used to describe the same or similar elements throughout the specification and the drawings and to the extent that an element is not described in detail with respect to this figure, it may be understood that the element is at least similar to a corresponding element that has been described elsewhere within the present disclosure.

While each drawing may represent one or more particular embodiments of the present disclosure, drawn to scale, such that the relative lengths, thicknesses, and angles can be inferred therefrom, it is to be understood that the present invention is not necessarily limited to the relative lengths, thicknesses, and angles shown. Changes to these values may be made within the spirit and scope of the present disclosure, for example, to allow for manufacturing limitations and the like.

Furthermore, the expression “being the same” may mean “being substantially the same”. Thus, the expression “being the same” may include a range that can be tolerated by those skilled in the art. The other expressions may also be expressions from which “substantially” has been omitted.

Embodiments of the present disclosure relate to a scan driver architecture for display devices that enhances power efficiency and operational consistency. The scan stages of the driver are organized in a particular manner so that they may interact with the pixel part of the display in a desired fashion. Each scan stage controls both an odd-numbered and an even-numbered scan line, and includes multiple buffer transistors that are carefully arranged to reduce signal delays and voltage deviations. This setup ensures a smoother and more uniform driving of the pixel rows across the display.

To further minimize power consumption and increase signal stability, the buffer clock lines, which control the timing of the signals sent by the buffer transistors, are routed between the buffer transistors and the pixel part of the display. This layout shortens the connection distances and thus reduces the electrical load on the clock lines. By doing so, the design minimizes timing mismatches and power loss that are typically associated with longer interconnections and varying signal propagation delays in traditional scan driver configurations.

The scan stages may be equipped with a logic circuit and a dedicated arrangement of, e.g., four buffer transistors per stage, aligned in specific spatial directions. The logic circuit receives carry signals and clock signals, enabling precise control over the signal flow between adjacent scan lines. The carry clock lines, which coordinate the timing between scan stages, are also arranged in a way that reduces their routing complexity and increases efficiency. These design refinements allow the scan driver to efficiently deliver scan pulses to alternating pixel groups while maintaining synchronized operation across the panel.

Embodiments of the present disclosure are not necessarily limited to display panels but may be integrated into electronic devices having high-performance displays, such as smartphones, tablet computers, wearables, automotive displays, and consumer appliances. By embedding a processor to generate grayscale data and using this scan driver design, the system achieves reduced power usage and increased reliability. The flexibility and modularity of this design also support a wide range of panel layouts and device types without sacrificing performance.

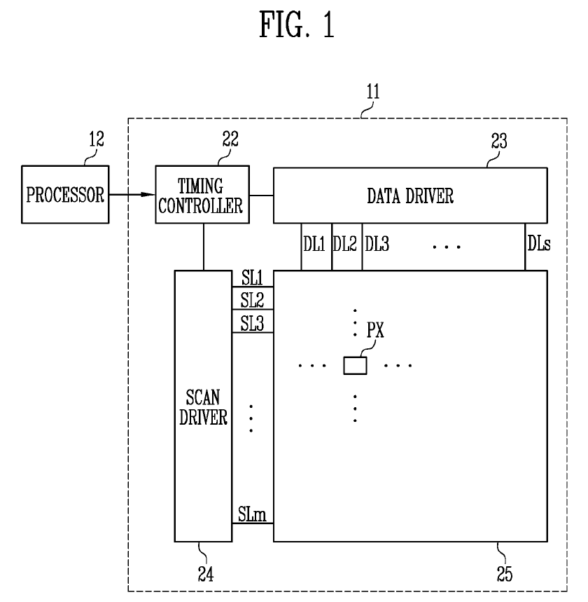

FIG. 1 is a schematic diagram illustrating a display device 11 according to an embodiment of the present disclosure.

Referring to FIG. 1, the display device 11, according to an embodiment of the present disclosure, may include a timing controller 22, a data driver 23, a scan driver 24, and a pixel part 25. The display device 11 may communicate with a processor 12.

The processor 12 may provide input grayscales and control signals for each image (or image frame). As used herein, the term “grayscales” refers to a digital image data value representing an intensity or brightness level for a pixel/subpixel in the display. These values are used to control the data voltages applied to the pixels, which in turn determine the luminance (i.e., how brightly each pixel emits light). Although the word “grayscale” may in other contexts imply black-and-white images, in this context, “grayscales” are used even for color images, because each subpixel (red, green, and blue) receives its own grayscale value to control its brightness. Together, these grayscale values for each color channel determine the final color and brightness of a pixel.

The processor 12 may correspond to a graphics processing unit (GPU), a central processing unit (CPU), an application processor (AP), or the like. The control signals may include a vertical synchronization signal, a horizontal synchronization signal, a data enable signal, and the like.

The vertical synchronization signal may include a plurality of pulses, and may indicate that a previous frame period ends and a current frame period begins based on a time point at which each of the pulses occurs. An interval between adjacent pulses of the vertical synchronization signal may correspond to one frame period. The horizontal synchronization signal may include a plurality of pulses, and may indicate that a previous horizontal period ends and a new horizontal period begins based on a time point at which each of the pulses occurs. An interval between adjacent pulses of the horizontal synchronization signal may correspond to one horizontal period. The data enable signal may have an enable level for particular horizontal periods and a disable level for the rest of the horizontal periods. The data enable signal at the enable level may indicate that input grayscales are supplied in the corresponding horizontal periods.

The timing controller 22 may supply the control signals to the scan driver 24 and the data driver 23. In addition, the timing controller 22 may provide the input grayscales to the data driver 23. The timing controller 22 may provide the data driver 23 with output grayscales obtained by compensating for or rendering the input grayscales to be suitable for the pixel part 25.

The data driver 23 may generate data voltages to be provided to data lines DL1, DL2, DL3, …, and DLs using the received grayscales and control signals. For example, the data driver 23 may sample the grayscales using a clock signal and apply data voltages corresponding to the grayscales to the data lines DL1 to DLs, where “s” may be a positive integer.

The scan driver 24 may receive a clock signal, a scan start signal, and the like from the timing controller 22 to generate scan signals to be provided to scan lines SL1, SL2, SL3, …, and SLm, where “m” may be a positive integer.

The scan driver 24 may sequentially supply scan signals having a turn-on level pulse to the scan lines SL1 to SLm. The scan driver 24 may include scan stages configured in the form of a shift register. The scan driver 24 may generate scan signals by sequentially transmitting a scan start signal in the form of a turn-on level pulse to a next scan stage under the control of the clock signal.

The pixel part 25 includes pixels. Each pixel PX may be connected to a corresponding data line and scan line. Pixels receiving the scan signal at the turn-on level through the scan line may receive the data voltage from the connected data line. The pixel receiving the data voltage may store the data voltage and emit light with a corresponding luminance.

Thus, the display device 11 including the processor 12, timing controller 22, data driver 23, scan driver 24, and pixel array (pixel part) 25, work together to convert grayscale image data into light output. Through coordinated timing and voltage control, the system drives the pixels to emit light and form the desired image.

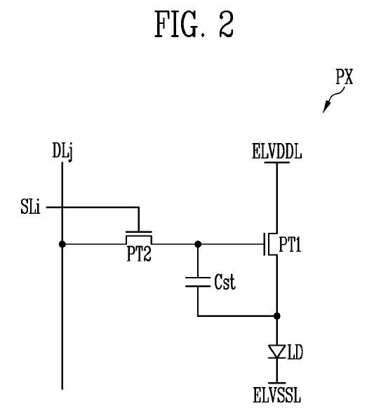

FIG. 2 is a circuit diagram illustrating the pixel PX, according to an embodiment of the present disclosure.

Referring to FIG. 2, the pixel PX includes transistors PT1 and PT2, a storage capacitor Cst, and a light emitting device LD.

Hereinafter, a circuit composed of N-type transistors will be described as an example. However, those skilled in the art will be able to design a circuit composed of P-type transistors by varying the polarity of a voltage applied to a gate terminal. Similarly, those skilled in the art will be able to design a circuit composed of a combination of P-type transistors and N-type transistors. A P-type transistor collectively refers to a transistor in which the amount of current conducted increases when a voltage difference between a gate electrode and a source electrode increases in a negative direction. An N-type transistor collectively refers to a transistor in which the amount of current conducted increases when a voltage difference between a gate electrode and a source electrode increases in a positive direction. Transistors may be configured in various forms such as a thin film transistor (TFT), a field effect transistor (FET), and a bipolar junction transistor (BJT).

A gate electrode of the first transistor PT1 may be connected to a first electrode of the storage capacitor Cst, a first electrode to a first power line ELVDDL, and a second electrode to a second electrode of the storage capacitor Cst. The first transistor PT1 may be referred to as a driving transistor.

A gate electrode of the second transistor PT2 may be connected to the i-th scan line SLi, a first electrode to the j-th data line DLj, and a second electrode to the gate electrode of the first transistor PT1. The second transistor PT2 may be referred to as a scan transistor.

The first electrode of the storage capacitor Cst may be connected to the gate electrode of the first transistor PT1, and the second electrode may be connected to the second electrode of the first transistor PT1.

The light emitting device LD may have an anode electrode connected to the second electrode of the first transistor PT1, and a cathode electrode connected to a second power line ELVSSL. The light emitting device LD may be configured as an organic light emitting diode (OLED), an inorganic light emitting diode, a quantum dot/well light emitting diode, or the like. Although the pixel PX in FIG. 2 is shown to include one light emitting device LD, in an embodiment, the pixel PX may include a plurality of light emitting devices connected in series, parallel, or in series and parallel.

A first power voltage may be applied to the first power line ELVDDL, and a second power voltage may be applied to the second power line ELVSSL. For example, during an image display period, the first power voltage may be greater than the second power voltage.

When a scan signal at a turn-on level (here, a high level) is applied through the scan line SLi, the second transistor PT2 is in a turn-on state. At this time, the data voltage applied to the data line DLj is stored in the first electrode of the storage capacitor Cst.

A positive driving current corresponding to a voltage difference between the first electrode and the second electrode of the storage capacitor Cst flows between the first electrode and the second electrode of the first transistor PT1. Accordingly, the light emitting device LD emits light at a luminance corresponding to the data voltage.

Next, when a scan signal at a turn-off level (here, a low level) is applied through the scan line SLi, the second transistor PT2 is turned off, and the data line DLj and the first electrode of the storage capacitor Cst are electrically separated. Therefore, even when the data voltage of the data line DLj changes, a voltage stored in the first electrode of the storage capacitor Cst does not change.

The embodiments may be applied not only to the pixel PX of FIG. 2 but also to pixels of other pixel circuits. For example, when the display device 11 further includes an emission driver, the pixel PX may further include a transistor connected to an emission line.

Thus, the pixel PX includes two transistors including a driving transistor PT1 and a scan transistor PT2, a storage capacitor Cst, and a light-emitting device LD, such as an OLED. When a scan signal is applied through the scan line SLi, scan transistor PT2 turns on, allowing the data voltage from data line DLj to be stored in Cst; this stored voltage then controls PT1 to drive current through LD, causing it to emit light, and the capacitor maintains this voltage even after PT2 is turned off, preserving the pixel’s luminance.

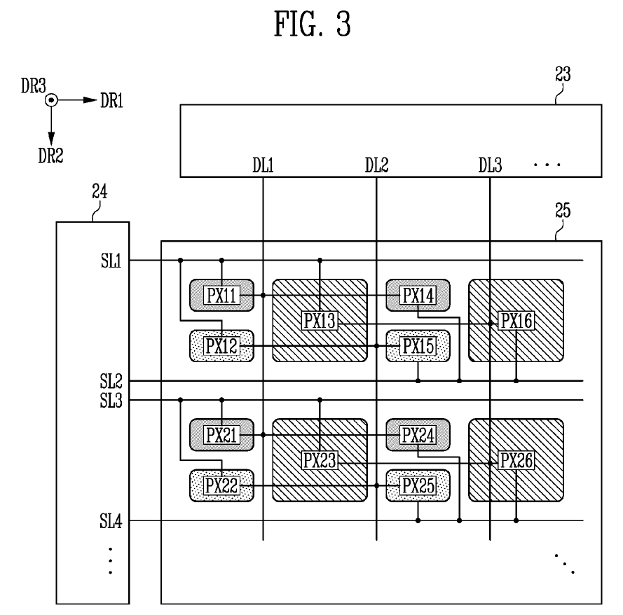

FIG. 3 is a schematic diagram illustrating the pixel part 25 according to an embodiment of the present disclosure.

Referring to FIG. 3, the pixel part 25, according to an embodiment of the present disclosure, may be connected to the data lines DL1, DL2, DL3, … of the data driver 23 and the scan lines SL1, SL2, SL3, and SL4 of the scan driver 24.

A first direction DR1 and a second direction DR2 are perpendicular to each other and may define a plane. A third direction DR3 is perpendicular to the first direction DR1 and the second direction DR2 and may define a height.

The pixel part 25 may include a plurality of pixels PX11, PX12, PX13, PX14, PX15, PX16, ..., PX21, PX22, PX23, PX24, PX25, PX26, ...

The pixel rows extending in the first direction DR1 may be arranged in the second direction DR2. For example, the first pixel row may include a plurality of pixels PX11, PX12, PX13, PX14, PX15, PX16, …. The second pixel row may include a plurality of pixels PX21, PX22, PX23, PX24, PX25, PX26, …. The first pixel row, the second pixel row, and the following pixel rows may be arranged in the second direction DR2.

Each of the pixel rows may be connected to an odd-numbered scan line and an even-numbered scan line. For example, the pixels PX11 to PX16 … in the first pixel row may be connected to the odd-numbered scan line SL1 and the even-numbered scan line SL2. One or more pixels PX11, PX12, PX13, … in the first pixel row may be connected to the odd-numbered scan line SL1, and other pixels PX14, PX15, PX16, … other than the one or more pixels PX11, PX12, PX13, … may be connected to the even-numbered scan line SL2. For example, adjacent pixels PX11, PX12, and PX13 which emit light of different colors in the first pixel row may form one group. Respective groups of the first pixel row may be alternately connected to the odd-numbered scan line SL1 and the even-numbered scan line SL2. Similarly, one or more pixels PX21, PX22, PX23, … in the second pixel row may be connected to the odd-numbered scan line SL3, and other pixels PX24, PX25, PX26, … other than the one or more pixels PX21, PX22, PX23, … may be connected to the even-numbered scan line SL4. For example, adjacent pixels PX21, PX22, and PX23 which emit light of different colors in the second pixel row may form one group. Respective groups of the second pixel row may be alternately connected to the odd-numbered scan line SL3 and the even-numbered scan line SL4.

According to this embodiment, the display device 11 may supply data voltages to the pixels PX11, … arranged at a high resolution by using a small number of data lines DL1, DL2, DL3, … without having a demultiplexer.

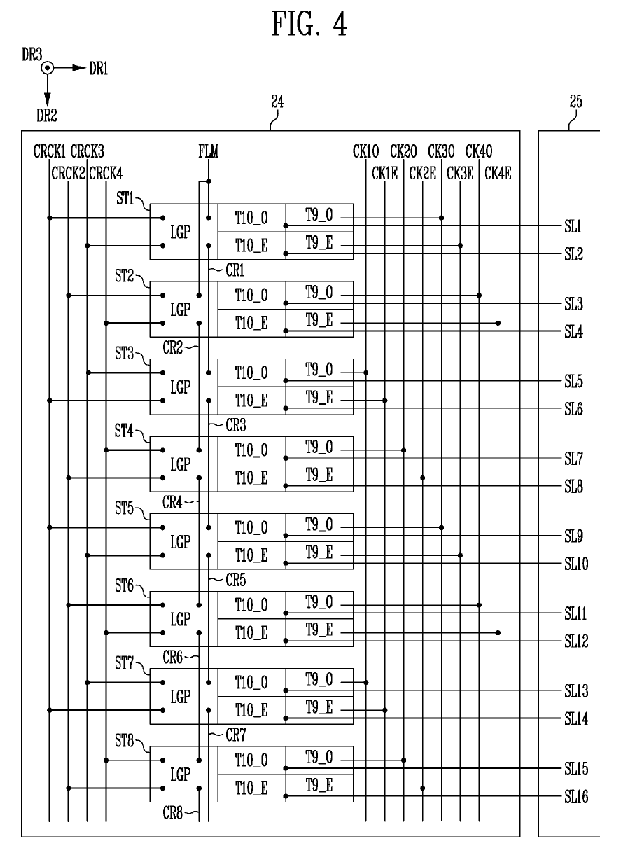

FIG. 4 is a schematic diagram illustrating the scan driver 24, according to an embodiment of the present disclosure.

Referring to FIG. 4, the scan driver 24 may include scan stages ST1, ST2, ST3, ST4, ST5, ST6, ST7, ST8, … each connected to an odd-numbered scan line and an even-numbered scan line. For example, the first scan stage ST1 may be connected to the odd-numbered scan line SL1 and the even-numbered scan line SL2. The second scan stage ST2 may be connected to the odd-numbered scan line SL3 and the even-numbered scan line SL4. The third scan stage ST3 may be connected to the odd-numbered scan line SL5 and the even-numbered scan line SL6. The fourth scan stage ST4 may be connected to the odd-numbered scan line SL7 and the even-numbered scan line SL8. The fifth scan stage ST5 may be connected to the odd-numbered scan line SL9 and the even-numbered scan line SL10. The sixth scan stage ST6 may be connected to the odd-numbered scan line SL11 and the even-numbered scan line SL12. The seventh scan stage ST7 may be connected to the odd-numbered scan line SL13 and the even-numbered scan line SL14. The eighth scan stage ST8 may be connected to the odd-numbered scan line SL15 and the even-numbered scan line SL16. The scan driver 24 may further include the ninth scan stage and following scan stages.

Components which are common to each of the scan stages ST1 to ST8 will be described with reference to the first scan stage ST1 and to the extent that an element is not described in detail with respect to this figure, it may be understood that the element is at least similar to a corresponding element that has been described elsewhere within the present disclosure.

The first scan stage ST1 may include a logic circuit LGP and buffer transistors T9_O, T10_O, T9_E, and T_10E. The logic circuit LGP may determine whether to turn on the buffer transistors T9_O, T10_O, T9_E, and T_10E based on a carry signal and a carry clock signal. Because the logic circuit LGP of each of the first scan stage ST1 and the second scan stage ST2 does not have a previous scan stage, a scan start signal may be received instead of a carry signal. For example, the timing controller 22 supplies a scan start signal at a turn-on level to a scan start line FLM, so that the scan driver 24 may sequentially supply scan signals at the turn-on level. Although the first scan stage ST1 and the second scan stage ST2 are shown to receive the same scan start signal in this embodiment, in an embodiment, the first scan stage ST1 and the second scan stage ST2 may receive different scan start signals. In this case, the first scan stage ST1 and the second scan stage ST2 are connected to different scan start lines. The scan start signal received by the second scan stage ST2 may be delayed by a predetermined amount of time compared to the scan start signal received by the first scan stage ST1.

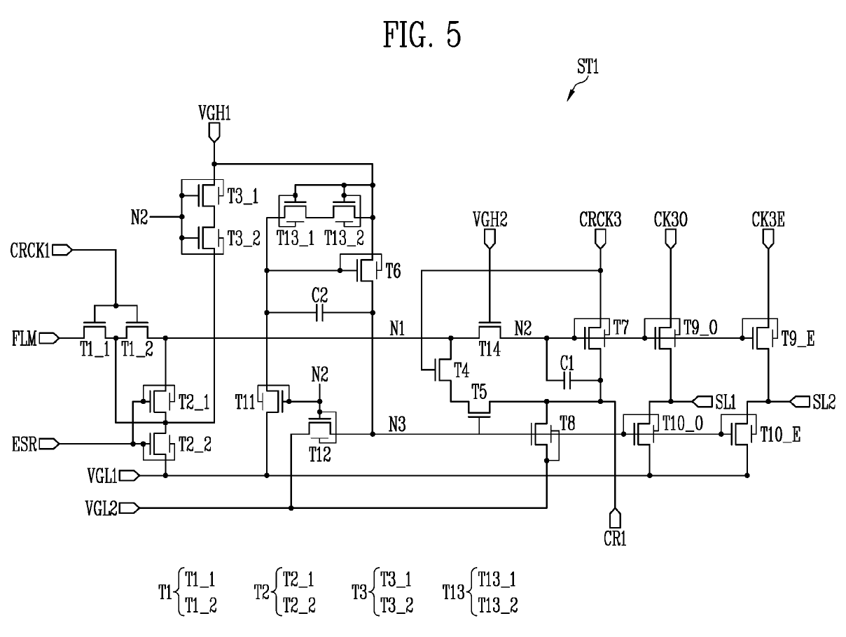

A first electrode of the first buffer transistor T9_O may be connected to an odd-numbered buffer clock line CK3O, a gate electrode may be connected to the logic circuit LGP, and a second electrode may be connected to the odd-numbered scan line SL1 (see FIG. 5). A first electrode of the second buffer transistor T10_O may be connected to the odd-numbered scan line SL1, and a gate electrode may be connected to the logic circuit LGP. A first electrode of the third buffer transistor T9_E may be connected to an even-numbered buffer clock line CK3E, a gate electrode may be connected to the logic circuit LGP, and a second electrode may be connected to the even-numbered scan line SL2. A first electrode of the fourth buffer transistor T10_E may be connected to the even-numbered scan line SL2, and a gate electrode may be connected to the logic circuit LGP.

The first buffer transistor T9_O may be disposed in the first direction DR1 with respect to the second buffer transistor T10_O. As used herein, the phrase, “may be disposed in a direction with respect to an element” may mean that the described item is disposed on one side of the element in the stated direction. The third buffer transistor T9_E may be disposed in the first direction DR1 with respect to the fourth buffer transistor T10_E.

The logic circuit LGP may be disposed in a direction opposite to the first direction DR1 with respect to the first buffer transistor T9_O, the second buffer transistor T10_O, the third buffer transistor T9_E, and the fourth buffer transistor T10_E.

The third buffer transistor T9_E may be disposed in the second direction DR2 with respect to the first buffer transistor T9_O, and the even-numbered scan line SL2 may be disposed in the second direction DR2 with respect to the odd-numbered scan line SL1. The fourth buffer transistor T10_E may be disposed in the second direction DR2 with respect to the second buffer transistor T10_O.

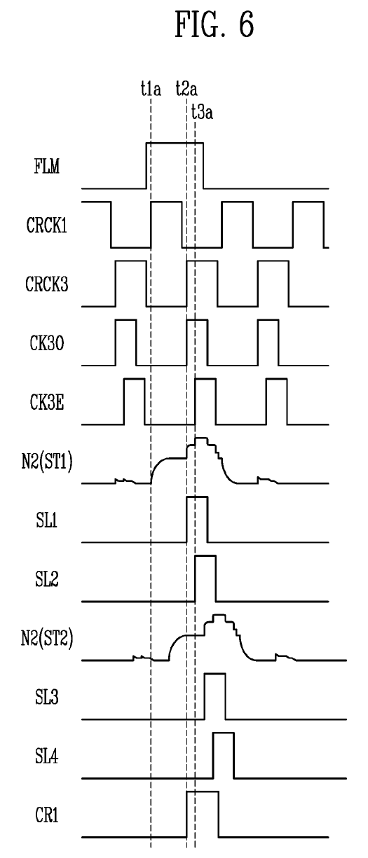

Carry clock lines CRCK1, CRCK2, CRCK3, and CRCK4 may be disposed in a direction opposite to the first direction DR1 with respect to the logic circuit LGP and may extend in the second direction DR2. The logic circuits LGP of the scan stages ST1 to ST8, … may be connected to the carry clock lines CRCK1, CRCK2, CRCK3, and CRCK4. The carry clock lines CRCK1 to CRCK4 may determine a time point at which the carry signal is generated. The carry clock signals applied to the carry clock lines CRCK1 to CRCK4 may be sequentially phase-delayed (see FIG. 6).

The odd-numbered scan stages ST1, ST3, ST5, ST7, … may be connected to the first carry clock line CRCK1 and the third carry clock line CRCK3. The carry clock lines CRCK1 and CRCK3 may be connected alternately to a gate electrode of a first transistor T1 and a gate electrode of a seventh transistor T7. The first scan stage ST1 may apply a carry signal at a turn-on level to a first carry line CR1 in response to the scan start signal at the turn-on level of the scan start line FLM. The third scan stage ST3 may apply a carry signal at a turn-on level to a third carry line CR3 in response to the carry signal at the turn-on level applied to the first carry line CR1. The fifth scan stage ST5 may apply a carry signal at a turn-on level to a fifth carry line CR5 in response to the carry signal at the turn-on level applied to the third carry line CR3. The seventh scan stage ST7 may apply a carry signal at a turn-on level to a seventh carry line CR7 in response to the carry signal at the turn-on level applied to the fifth carry line CR5.

Similarly, the even-numbered scan stages ST2, ST4, ST6, ST8, … may be connected to the second carry clock line CRCK2 and the fourth carry clock line CRCK4. The carry clock lines CRCK2 and CRCK4 may be connected alternately to the gate electrode of the first transistor T1 and the gate electrode of the seventh transistor T7. The second scan stage ST2 may apply a carry signal at a turn-on level to a second carry line CR2 in response to the scan start signal at the turn-on level of the scan start line FLM. The fourth scan stage ST4 may apply a carry signal at a turn-on level to a fourth carry line CR4 in response to the carry signal at the turn-on level applied to the second carry line CR2. The sixth scan stage ST6 may apply a carry signal at a turn-on level to a sixth carry line CR6 in response to the carry signal at the turn-on level applied to the fourth carry line CR4. The eighth scan stage ST8 may apply a carry signal at a turn-on level to an eighth carry line CR8 in response to the carry signal at the turn-on level applied to the sixth carry line CR6.

Buffer clock lines CK1O, CK1E, CK2O, CK2E, CK3O, CK3E, CK4O, and CK4E may extend in the second direction DR2 between the buffer transistors T9_O and T9_E and the pixel part 25. The buffer clock lines CK1O to CK4E may determine levels and timings of scan signals output to the buffer transistors T9_O and T9_E. Buffer clock signals applied to the buffer clock lines CK1O, CK1E, CK2O, CK2E, CK3O, CK3E, CK4O, and CK4E may be sequentially delayed at a predetermined time interval (see FIG. 6).

In this embodiment, in units of four scan stages, the scan stages may be connected to an adjacent odd-numbered buffer clock line and an adjacent even-numbered buffer clock line. For example, the third scan stage ST3 may be connected to the odd-numbered first buffer clock line CK1O and the even-numbered first buffer clock line CK1E. The fourth scan stage ST4 may be connected to the odd-numbered second buffer clock line CK2O and the even-numbered second buffer clock line CK2E. The fifth scan stage ST5 may be connected to the odd-numbered third buffer clock line CK3O and the even-numbered third buffer clock line CK3E. The sixth scan stage ST6 may be connected to the odd-numbered fourth buffer clock line CK4O and the even-numbered fourth buffer clock line CK4E.

According to this embodiment, the connection distance between the buffer clock line CK1O, CK1E, CK2O, CK2E, CK3O, CK3E, CK4O, or CK4E and the buffer transistor T9_O or T9_E may be the shortest distance. Therefore, the load deviation of the buffer clock lines CK1O, CK1E, CK2O, CK2E, CK3O, CK3E, CK4O, and CK4E may decrease, and the deviation of the scan signals output to the buffer transistors T9_O and T9_E may also decrease. There is also an effect of reducing power consumption due to the reduction of load.

FIG. 5 is a circuit diagram illustrating a scan stage according to an embodiment of the present disclosure.

Referring to FIG. 5, the first scan stage ST1, according to an embodiment of the present disclosure, may include a plurality of transistors T1, T2, T3, T4, T5, T6, T7, T8, T9_O, T9_E, T10_O, T10_E, T11, T12, T13, and T14 and a plurality of capacitors C1 and C2. The scan stages other than the first scan stage ST1 may have the same circuit structure, and thus, to the extent that an element is not described in detail with respect to this figure, it may be understood that the element is at least similar to a corresponding element that has been described elsewhere within the present disclosure.

Hereinafter, a circuit composed of N-type transistors will be described as an example. However, those skilled in the art will be able to design a circuit composed of P-type transistors by varying the polarity of a voltage applied to a gate terminal. Similarly, those skilled in the art will be able to design a circuit composed of a combination of P-type transistors and N-type transistors.

The gate electrode of the first transistor T1 may be connected to the first carry clock line CRCK1, a first electrode may be connected to the scan start line FLM, and a second electrode may be connected to a first node N1. The first transistor T1 may include sub-transistors T1_1 and T1_2 connected in series.

A gate electrode of the second transistor T2 may be connected to a reset line ESR, a first electrode may be connected to the first node N1, and a second electrode may be connected to a first low voltage line VGL1. The second transistor T2 may also include a back gate electrode connected to the gate electrode. The second transistor T2 may include sub-transistors T2_1 and T2_2 connected in series. An electrode between the sub-transistors T1_1 and T1_2 and an electrode between the sub-transistors T2_1 and T2_2 may be connected to each other.

When the display device 11 is powered on, a reset signal at a turn-on level (high level) may be applied to the reset line ESR. The reset signal may be applied to all scan stages in common. Thereafter, during an operation of the display device 11, the reset signal at a turn-off level (low level) may be maintained in the reset line ESR.

A gate electrode of the third transistor T3 may be connected to a second node N2, a first electrode may be connected to a first high voltage line VGH1, and a second electrode may be connected to the electrode between the sub-transistors T1_1 and T1_2 and the electrode between the sub-transistors T2_1 and T2_2. The third transistor T3 may also include a back gate electrode connected to the gate electrode. The third transistor T3 may include sub-transistors T3_1 and T3_2 connected in series.

The fourth transistor T4 may include a gate electrode connected to the third carry clock line CRCK3, a first electrode connected to the first node N1, and a second electrode.

A gate electrode of the fifth transistor T5 may be connected to a third node N3, a first electrode may be connected to the second electrode of the fourth transistor T4, and a second electrode may be connected to the first carry line CR1.

The sixth transistor T6 may include a gate electrode, a first electrode connected to the first high voltage line VGH1, and a second electrode connected to the third node N3. The sixth transistor T6 may also include a back gate electrode connected to the gate electrode.

The second capacitor C2 may be connected between the gate electrode of the sixth transistor T6 and the second electrode of the sixth transistor T6.

A gate electrode of the seventh transistor T7 may be connected to the second node N2, a first electrode may be connected to the third carry clock line CRCK3, and a second electrode may be connected to the first carry line CR1. The seventh transistor T7 may also include a back gate electrode connected to the gate electrode.

The first capacitor C1 may be connected between the gate electrode of the seventh transistor T7 and the second electrode of the seventh transistor T7.

A gate electrode of the eighth transistor T8 may be connected to the third node N3, a first electrode may be connected to the first carry line CR1, and a second electrode may be connected to a second low voltage line VGL2. The eighth transistor T8 may also include a back gate electrode connected to the second electrode of the eighth transistor T8. A voltage level of a second low voltage applied to the second low voltage line VGL2 may be lower than a voltage level of a first low voltage applied to the first low voltage line VGL1.

A gate electrode of the odd-numbered ninth transistor T9_O may be connected to the second node N2, a first electrode may be connected to the odd-numbered third buffer clock line CK3O, and a second electrode may be connected to the first scan line SL1. The odd-numbered ninth transistor T9_O may also include a back gate electrode connected to the gate electrode. The odd-numbered ninth transistor T9_O may be the first buffer transistor T9_O of FIG. 4.

A gate electrode of the odd-numbered tenth transistor T10_O may be connected to the third node N3, a first electrode may be connected to the first scan line SL1, and a second electrode may be connected to the first low voltage line VGL1. The odd-numbered tenth transistor T10_O may also include a back gate electrode connected to the gate electrode. The odd-numbered tenth transistor T10_O may be the second buffer transistor T10_O of FIG. 4.

A gate electrode of the even-numbered ninth transistor T9_E may be connected to the second node N2, a first electrode may be connected to the even-numbered third buffer clock line CK3E, and a second electrode may be connected to the second scan line SL2. The even-numbered ninth transistor T9_E may also include a back gate electrode connected to the gate electrode. The even-numbered ninth transistor T9_E may be the third buffer transistor T9_E of FIG. 4.

A gate electrode of the even-numbered tenth transistor T10_E may be connected to the third node N3, a first electrode may be connected to the second scan line SL2, and a second electrode may be connected to the first low voltage line VGL1. The even-numbered tenth transistor T10_E may also include a back gate electrode connected to the gate electrode. The even-numbered tenth transistor T10_E may be the fourth buffer transistor T10_E of FIG. 4.

A gate electrode of the eleventh transistor T11 may be connected to the second node N2, a first electrode may be connected to the gate electrode of the sixth transistor T6, and a second electrode may be connected to the first low voltage line VGL1. The eleventh transistor T11 may also include a back gate electrode connected to the gate electrode.

A gate electrode of the twelfth transistor T12 may be connected to the second node N2, a first electrode may be connected to the second low voltage line VGL2, and a second electrode may be connected to the third node N3. The twelfth transistor T12 may also include a back gate electrode connected to the gate electrode.

A gate electrode of the thirteenth transistor T13 may be connected to the first high voltage line VGH1, a first electrode may be connected to the gate electrode of the sixth transistor T6, and a second electrode may be connected to the first high voltage line VGH1. The thirteenth transistor T13 may include sub-transistors T13_1 and T13_2 connected in series. The thirteenth transistor T13 may also include a back gate electrode connected to the gate electrode.

A gate electrode of the fourteenth transistor T14 may be connected to a second high voltage line VGH2, a first electrode may be connected to the first node N1, and a second electrode may be connected to the second node N2.

FIG. 6 is a waveform diagram illustrating a method of driving a scan stage according to an embodiment of the present disclosure.

Referring to FIG. 6, a scan start signal of the scan start line FLM, a first carry clock signal of the first carry clock line CRCK1, a third carry clock signal of the third carry clock line CRCK3, an odd-numbered third buffer clock signal of the odd-numbered third buffer clock line CK3O, an even-numbered third buffer clock signal of the even-numbered third buffer clock line CK3E, a voltage of the second node N2 of the first scan stage ST1, a first scan signal of the first scan line SL1, a second scan signal of the second scan line SL2, a voltage of the second node N2 of the second scan stage ST2, a third scan signal of the third scan line SL3, a fourth scan signal of the fourth scan line SL4, and a first carry signal of the first carry line CR1 are shown in an embodiment.

At a time point t1a, the first transistor T1 is turned on by the first carry clock signal at a turn-on level (high level). Therefore, the scan start signal at the turn-on level (high level) is applied to the first node N1. At this time, the fourteenth transistor T14 is in a turn-on state due to a second high voltage of the second high voltage line VGH2. Therefore, a voltage at the turn-on level (high level) may also be applied to the second node N2. Accordingly, the seventh transistor T7 and the ninth transistors T9_O and T9_E may be turned on.

At a time point t2a, the first carry signal at the turn-on level is output by the third carry clock signal at the turn-on level (high level). In addition, the first scan signal at the turn-on level (high level) is output to the first scan line SL1 through the odd-numbered ninth transistor T9_O by the odd-numbered third buffer clock signal at the turn-on level (high level).

At a time point t3a, the second scan signal at the turn-on level (high level) is output to the second scan line SL2 through the even-numbered ninth transistor T9_E by the even-numbered third buffer clock signal at the turn-on level (high level).

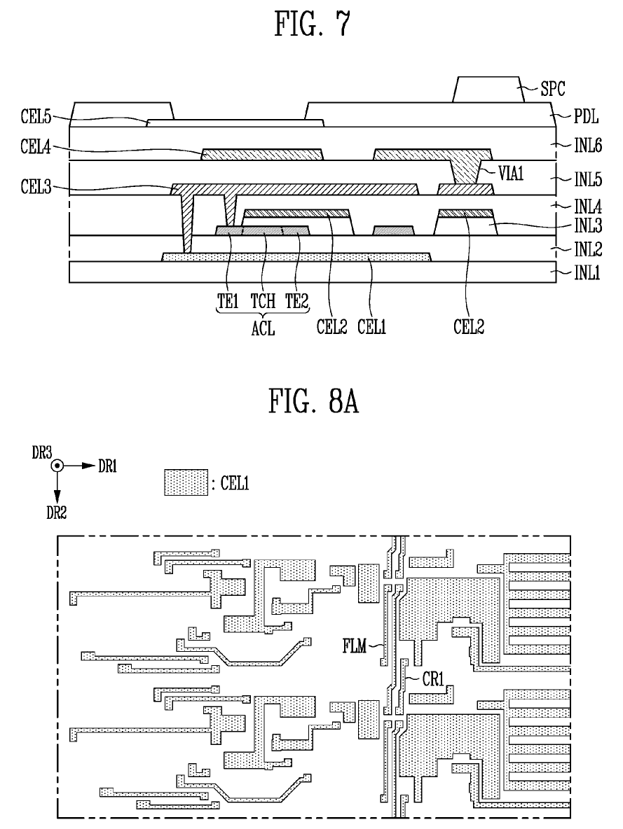

FIG. 7 is a cross-sectional view of the display device 11 according to an embodiment of the present disclosure.

Referring to FIG. 7, the display device 11, according to an embodiment of the present disclosure, may include a plurality of insulating layers INL1, INL2, INL3, INL4, INL5, and INL6, a plurality of electrode layers CEL1, CEL2, CEL3, CEL4, and CEL5, an active layer ACL, a pixel defining layer PDL, and a spacer SPC.

A substrate may be present under the first insulating layer INL1. The substrate may include various materials such as glass, polymer, metal, or the like. The substrate may be selected as either a rigid substrate or a flexible substrate depending on an applied product. When the substrate is configured to include a polymeric organic material, the substrate may be composed of polystyrene, polyvinyl alcohol, polymethyl methacrylate, polyethersulfone, polyacrylate, polyetherimide, polyethylene naphthalate, polyethylene terephthalate, polyphenylene sulfide, polyarylate, polyimide, polycarbonate, triacetate cellulose, cellulose acetate propionate, or the like. The substrate may be composed of fiber glass reinforced plastic (FRP).

The insulating layers INL1, INL2, INL3, INL4, INL5, and INL6, the pixel defining layer PDL, and the spacer SPC may be composed of an organic insulating layer, an inorganic insulating layer, an organic/inorganic insulating layer, or the like, and may be a single layer or multiple layers. For example, the insulating layers INL1 to INL6 may include at least one of a silicon nitride (SiNx), a silicon oxide (SiOx), a silicon nitric oxide (SiOxNy), an acrylic resin, an epoxy resin, a phenolic resin, a polyamide resin, or a polyimide resin.

The electrode layers CEL1, CEL2, CEL3, CEL4, and CEL5 may each be a single layer or multiple layers, and may be composed of known conductors such as gold (Au), silver (Ag), aluminum (Al), molybdenum (Mo), chromium (Cr), titanium (Ti), nickel (Ni), neodymium (Nd), copper (Cu), and platinum (Pt).

The first electrode layer CEL1 may be positioned on the first insulating layer INL1. The first electrode layer CEL1 may include back gate electrodes of transistors and one electrode of a capacitor.

The second insulating layer INL2 may be positioned on the first electrode layer CEL1. The active layer ACL may be positioned on the second insulating layer INL2. The active layer ACL may include a channel TCH a first electrode TE1, and a second electrode TE2 of a transistor. The active layer ACL may be a semiconductor layer. The semiconductor layer may be composed of an oxide semiconductor or a polysilicon semiconductor. The first electrode TE1 and the second electrode TE2 may be doped with impurities to be conductive. In addition, the active layer ACL may include the one electrode of the capacitor.

The third insulating layer INL3 may be positioned on the active layer ACL. The second electrode layer CEL2 may be positioned on the third insulating layer INL3. The second electrode layer CEL2 may include gate electrodes of transistors and the one electrode of the capacitor.

The fourth insulating layer INL4 may be positioned on the second electrode layer CEL2. The third electrode layer CEL3 may be positioned on the fourth insulating layer INL4. The third electrode layer CEL3 may be connected to the active layer ACL or the first electrode layer CEL1 through a contact hole. According to an embodiment, the third electrode layer CEL3 may be connected to the second electrode layer CEL2 through a contact hole. The third electrode layer CEL3 may constitute various wires, gate electrodes of transistors, and electrodes of capacitors.

The fifth insulating layer INL5 may be positioned on the third electrode layer CEL3. The fourth electrode layer CEL4 may be positioned on the fifth insulating layer INL5. The fourth electrode layer CEL4 may be connected to the third electrode layer CEL3 through a via hole. A via electrode VIA1 may be disposed in the via hole. In the fourth electrode layer CEL4, electrode lines requiring a large area, such as a power line or a voltage supply line, may be disposed.

The sixth insulating layer INL6 may be positioned on the fourth electrode layer CEL4. The fifth electrode layer CEL5 may be positioned on the sixth insulating layer INL6. The fifth electrode layer CEL5 may include an anode electrode of the light emitting device LD.

The pixel defining layer PDL may be positioned on the fifth electrode layer CEL5. The pixel defining layer PDL may include openings defining the area of emission of the light emitting device LD.

The spacer SPC may be disposed on the pixel defining layer PDL. The spacer SPC may be present for the purpose of preventing or mitigating a leakage current or preventing or mitigating light spreading by cutting a common layer of the light emitting device LD.

Thus, the structure and operation of the pixel part and scan driver in a display device may be as described above. Pixels are arranged in rows and connected to both odd- and even-numbered scan lines, enabling efficient data delivery without a demultiplexer. The scan driver contains scan stages, each with logic circuits and buffer transistors, that sequentially activate scan lines using carry signals and buffer clock lines. The detailed circuit of each scan stage may include multiple transistors and capacitors designed to control signal timing and stability. Additionally, the display device’s layered physical construction, comprising insulating layers, electrode layers, a semiconductor active layer, and light-emitting components, is engineered to support precise electrical performance and minimize light leakage or interference.

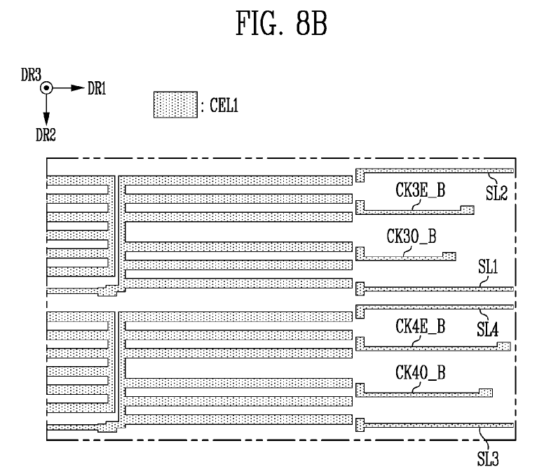

FIGS. 8A to 13B show plan view layouts of scan stages according to an embodiment of the present disclosure.

For convenience of description, the layouts of the first scan stage ST1 and the second scan stage ST2 disposed in the second direction DR2 with respect to the first scan stage ST1 are shown as examples.

FIGS. 8A and 8B show a portion of the first electrode layer CEL1. A part shown in FIG. 8B may be disposed in the first direction DR1 with respect to a part shown in FIG. 8A.

Referring to FIGS. 8A and 8B, the first electrode layer CEL1 may include the scan start line FLM, the first carry line CR1, the first to fourth scan lines SL1, SL2, SL3, and SL4, a bridge CK3E_B of the even-numbered third buffer clock line CK3E, a bridge CK3O_B of the odd-numbered third buffer clock line CK3O, a bridge CK4E_B of the even-numbered fourth buffer clock line CK4E, and a bridge CK4O_B of the odd-numbered fourth buffer clock line CK4O. The bridges CK3E_B, CK3O_B, CK4E_B, and CK4O_B may each connect a corresponding buffer clock line and a corresponding buffer transistor.

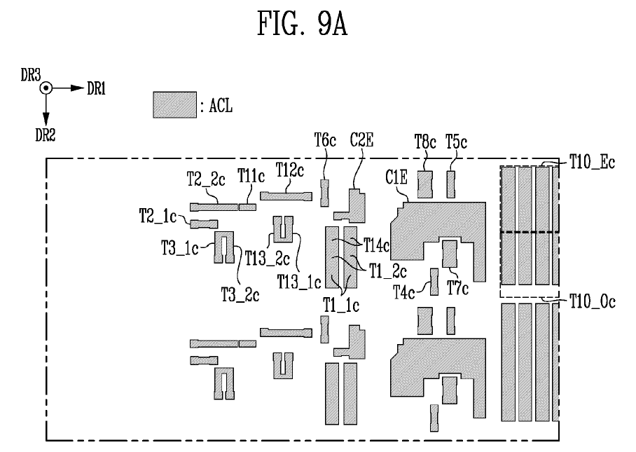

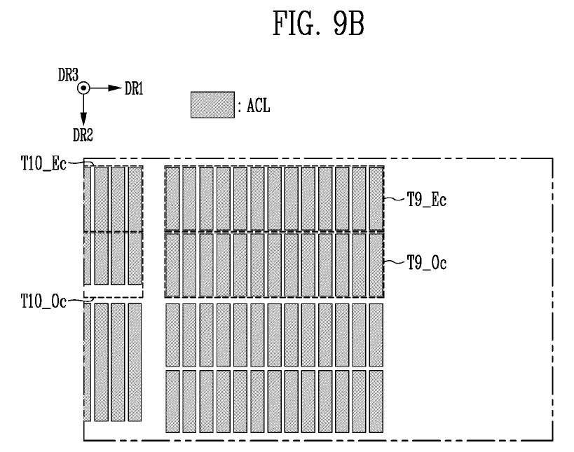

FIGS. 9A and 9B show a portion of the active layer ACL. A part shown in FIG. 9B may be disposed in the first direction DR1 with respect to a part shown in FIG. 9A.

Referring to FIGS. 9A and 9B, the active layer ACL may include channels T1_1c and T1_2c of the sub-transistors T1_1 and T1_2 of the first transistor T1, channels T2_1c and T2_2c of the sub-transistors T2_1 and T2_2 of the second transistor T2, channels T3_1c and T3_2c of the sub-transistors T3_1 and T3_2 of the third transistor T3, a channel T4c of the fourth transistor T4, a channel T5c of the fifth transistor T5, a channel T6c of the sixth transistor T6, a channel T7c of the seventh transistor T7, a channel T8c of the eighth transistor T8, a channel T9_Oc of the odd-numbered ninth transistor T9_O, a channel T9_Ec of the even-numbered ninth transistor T9_E, a channel T10_Oc of the odd-numbered tenth transistor T10_O, a channel T10_Ec of the even-numbered tenth transistor T10_E, a channel T11c of the eleventh transistor T11, a channel T12c of the twelfth transistor T12, channels T13_1c and T13_2c of the sub-transistors T13_1 and T13_2 of the thirteenth transistor T13, and a channel T14c of the fourteenth transistor T14.

In the embodiment shown in FIGS. 9A and 9B, the channel T9_Oc of the first buffer transistor T9_O may be disposed in the second direction DR2 with respect to the channel T9_Ec of the third buffer transistor T9_E. The odd-numbered scan line SL1 may be disposed in the second direction DR2 with respect to the even-numbered scan line SL2 (see FIG. 8B). The channel T10_Oc of the second buffer transistor T10_O may be disposed in the second direction DR2 with respect to the channel T10_Ec of the fourth buffer transistor T10_E.

For example, the positions of the buffer transistors of the present embodiment may be different from those shown in FIG. 4. However, by changing the positions of the bridge CK3E_B of the even-numbered third buffer clock line CK3E and the bridge CK3O_B of the odd-numbered third buffer clock line CK3O, a person skilled in the art may easily implement the embodiment shown in FIG. 4 with a layout (see FIG. 8B).

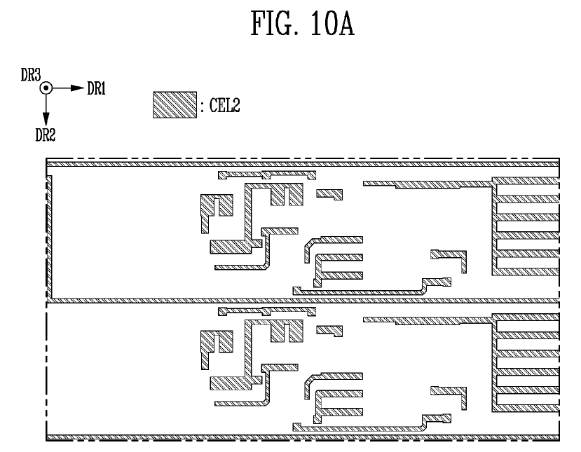

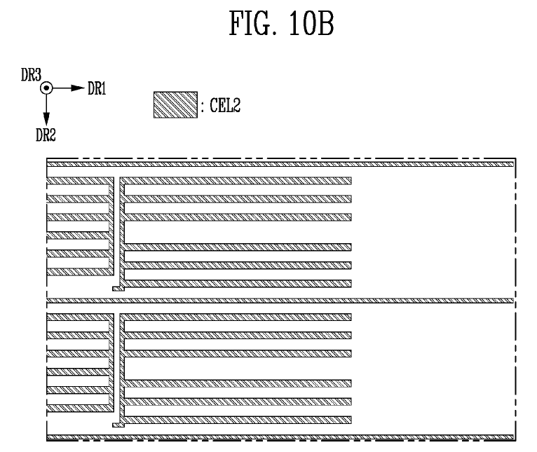

FIGS. 10A and 10B show a portion of the second electrode layer CEL2. A part shown in FIG. 10B may be disposed in the first direction DR1 with respect to a part shown in FIG. 10A.

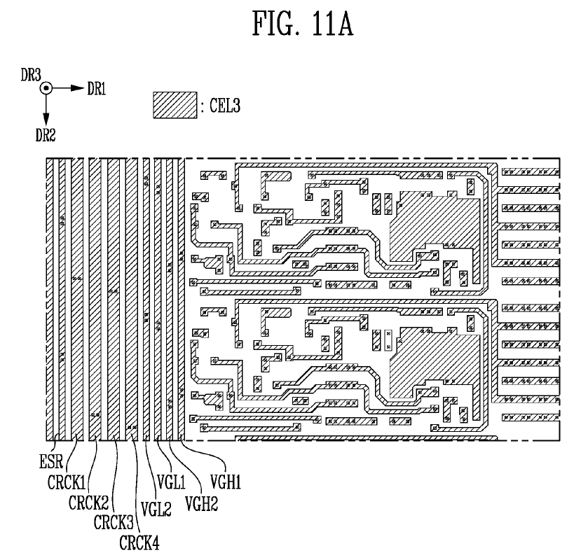

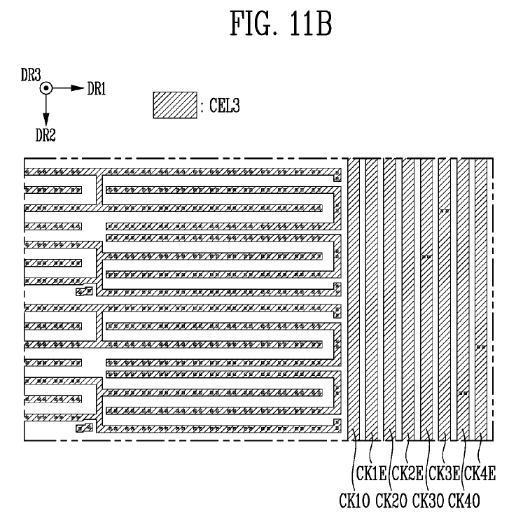

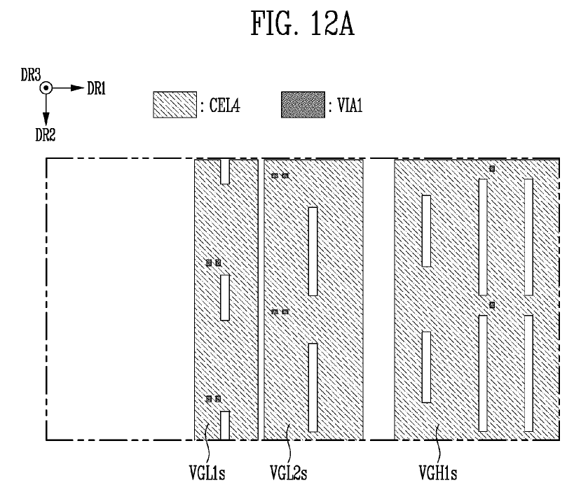

FIGS. 11A and 11B show a portion of the third electrode layer CEL3. A part shown in FIG. 11B may be disposed in the first direction DR1 with respect to a part shown in FIG. 11A.

Referring to FIGS. 11A and 11B, the third electrode layer CEL3 may include the reset line ESR, the carry clock lines CRCK1, CRCK2, CRCK3, and CRCK4, the voltage lines VGH1, VGH2, VGL1, and VGL2, and the buffer clock lines CK1O, CK2O, CK3O, CK4O, CK1E, CK2E, CK3E, and CK4E extending in the second direction DR2.

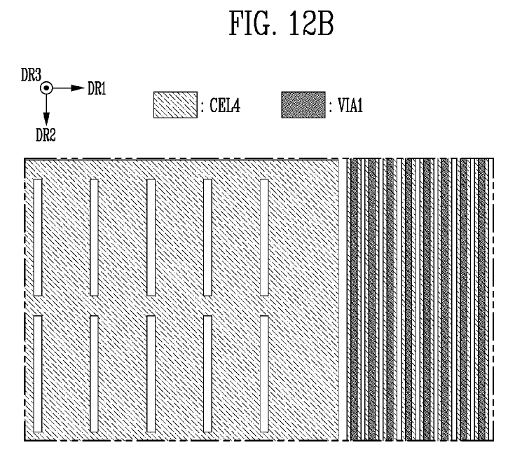

FIGS. 12A and 12B show a portion of the fourth electrode layer CEL4 and the via electrode VIA1. A part shown in FIG. 12B may be disposed in the first direction DR1 with respect to a part shown in FIG. 12A.

Referring to FIGS. 12A and 12B, the fourth electrode layer CEL4 may include sub-voltage lines VGH1s, VGL1s, and VGL2s having a large area. For example, the sub-voltage line VGH1s may be connected to the first high voltage line VGH1. The sub-voltage line VGL1s may be connected to the first low voltage line VGL1. The sub-voltage line VGL2s may be connected to the second low voltage line VGL2.

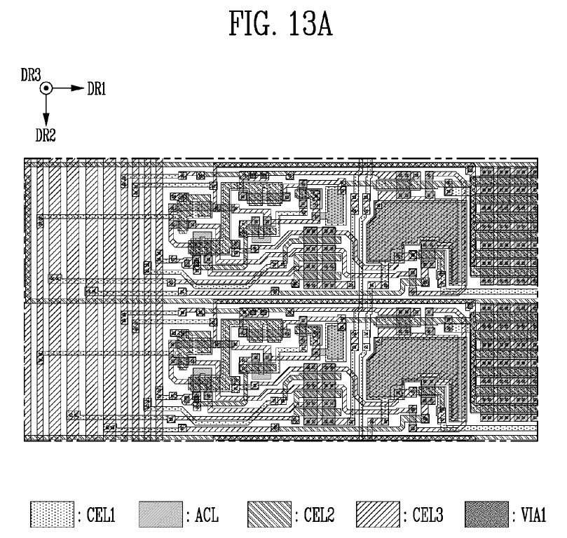

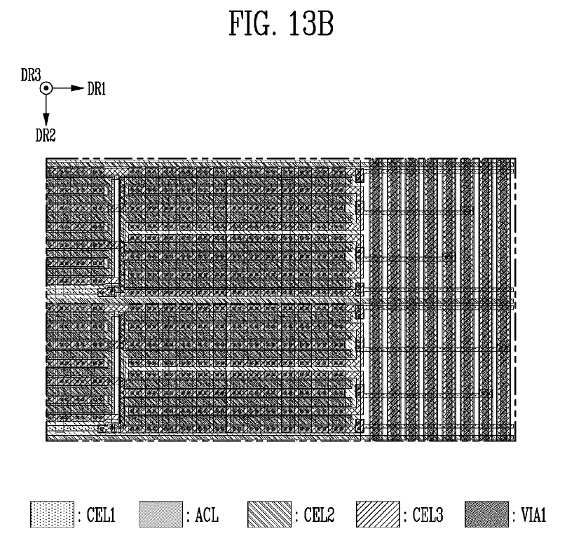

FIG. 13A shows a layout in which FIGS. 9A, 10A, 11A, and 12A overlap. However, to improve visibility, from among the configurations shown in FIG. 12A, only the via electrode VIA1 is shown, and the configuration of the fourth electrode layer CEL4 is excluded.

FIG. 13B shows a layout in which FIGS. 9B, 10B, 11B, and 12B overlap. However, to improve visibility, from among the configurations shown in FIG. 12B, only the via electrode VIA1 is shown, and the configuration of the fourth electrode layer CEL4 is excluded.

Thus, according to the above-described layered physical layout of scan stages in the display device, focusing on how transistors, scan lines, and buffer clock lines are arranged across multiple electrode and active layers, different components, such as bridges, clock lines, and sub-transistor channels, are positioned relative to each other in the first and second directions, and layout adjustments can be made to support alternative circuit configurations without altering the underlying electrical design.

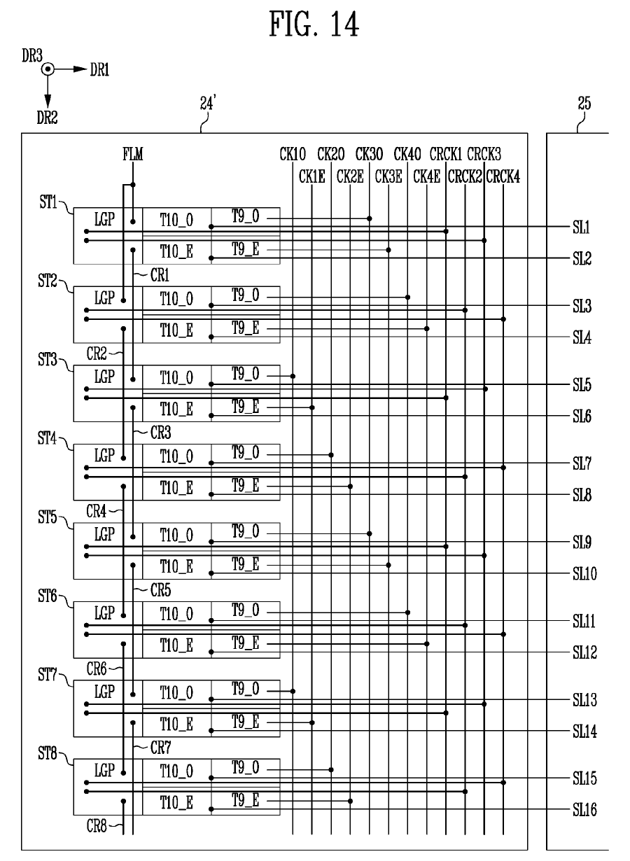

FIG. 14 is a diagram illustrating a scan driver 24’ according to an embodiment of the present disclosure.

Referring to FIG. 14, the carry clock lines CRCK1 to CRCK4 extend in the second direction DR2 between the buffer transistors T9_O and T9_E and the pixel part 25, which is different from the scan driver 24 according to the embodiment of FIG. 4. The embodiment of FIG. 14 shows the possibility that the embodiment of FIG. 4 may be variously modified.

The display device, according to the embodiment, may be applied to various electronic devices. The electronic device, according to the embodiment, includes the above-described display device, and may further include a module or device having an additional function in addition the display device.

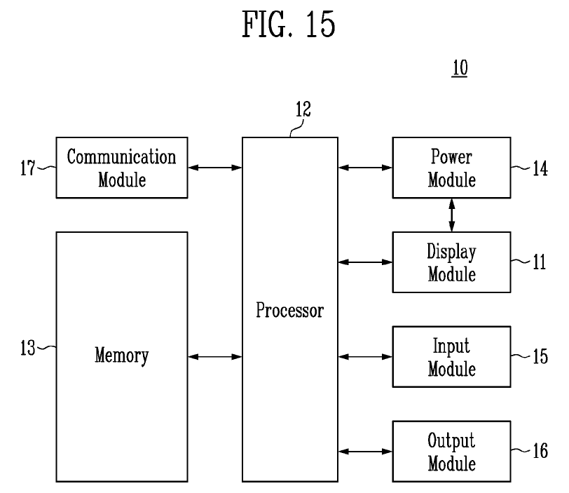

FIG. 15 is a schematic block diagram of an electronic device 10, according to an embodiment. Referring to FIG. 15, the electronic device 10, according to an embodiment, may include a display module (or display device) 11, the processor 12, memory 13, and a power module 14.

The processor 12 may include at least one of a central processing unit (CPU), an application processor (AP), a graphics processing unit (GPU), a communication processor (CP), an image signal processor (ISP), and a controller. In an embodiment, the processor 12 may be provided in two or more divisions from a functional or structural point of view. For example, the processor 12 may include a main processor in the form of a first driving chip including a CPU, and an auxiliary processor in the form of a second driving chip including a controller which receives an image signal from the main processor and processes the image signal to conform to an interface specification of the display module 11. The processor 12 may provide grayscales of an image frame. The display module (or display device) 11 may display an image using the received grayscales.

The memory 13 may include at least one of non-volatile memory or volatile memory. The memory 13 may store data information necessary for an operation of the processor 12 or the display module 11. When the processor 12 executes an application stored in the memory 13, an image data signal and/or an input control signal are transmitted to the display module 11, and the display module 11 may process the received signal and output image information through a display screen.

The power module 14 may include a power supply module such as a power adapter or a battery device, and a power conversion module which converts power supplied by the power supply module to generate power necessary for an operation of the electronic device 10. The power conversion by the power conversion module may include, but is not necessarily limited to, DC-DC conversion, AC-DC conversion, and DC-AC conversion.

The electronic device 10 may further include an input module 15, a non-image output module 16, and/or a communication module 17.

The input module 15 may provide input information to the processor 12 and/or the display module 11. The input module 15 may include various sensor modules as well as a physical button, a keyboard, and a microphone. Examples of the sensor modules may include a touch sensor, a pressure sensor, a distance sensor, a position sensor, a digitizer, a motion recognition sensor, a camera sensor, a light receiving sensor, a photoelectric conversion sensor, a temperature sensor, as well as a biometric sensor such as a blood pressure sensor, a blood glucose sensor, an electrocardiogram sensor, a heart rate sensor, and the like.

The non-image output module 16 may receive information other than the image received from the processor 12 and provide the information to a user. Examples of the non-image output module 16 include an acoustic module, a haptic module, a light emitting module, or the like, and may include other functional modules unique to electronic devices (e.g., a cooling module of a refrigerator, or the like).

The communication module 17 is a module which is responsible for transmitting and receiving information between the electronic device 10 and an external device, and may include a receiving unit and a transmitting unit. The communication module 17 may include various wireless communication modules such as a mobile communication module, a Wi-Fi module, and a Bluetooth module, or various wired communication modules.

At least one of the above-described components of the electronic device 10 may be included in the display device according to the above-described embodiments. In addition, one or more of individual modules which are functionally included in one module may be included in the display device, and others may be provided separately from the display device. For example, the display device includes the display module 11, and the processor 12, the memory 13, and the power module 14 may be provided in the form of other devices in the electronic device 10 other than the display device. In another example, the power module 14 may be provided in the display device, and supply power to the processor 12 and the memory 13 provided in the electronic device 10 other than the display device, but the components are not necessarily limited to the above-mentioned examples.

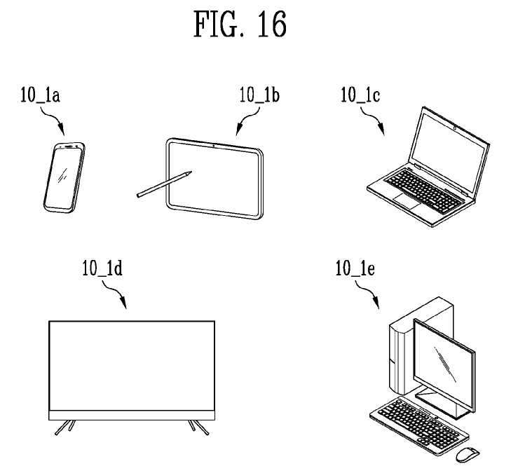

FIGS. 16 to 18 are perspective schematic diagrams of electronic devices according to various embodiments. FIGS. 16 to 18 illustrate examples of various electronic devices to which a display device according to embodiments is applied.

FIG. 16 illustrates a smartphone 10_1a, a tablet computer 10_1b, a laptop/notebook computer 10_1c, a TV 10_1d, and a computer monitor 10_1e as examples of electronic devices.

The smartphone 10_1a may include an input module such as a touch sensor and a communication module in addition to the display module 11. The smartphone 10_1a may process information received through the communication module or another input module and display the information through a display module of a display device.

Each of the tablet computer 10_1b, the laptop/notebook computer 10_1c, the TV 10_1d, and the computer monitor 10_1e also includes a display module and an input module similarly to the smartphone 10_1a, and may further include a communication module in some cases.

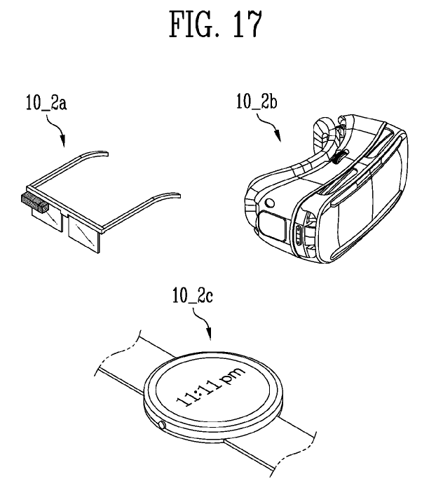

FIG. 17 illustrates a case where an electronic device including a display module is applied to a wearable electronic device. The wearable electronic device may be smart glasses 10_2a, a head-mounted display 10_2b, a smart watch 10_2c, or the like.

The smart glasses 10_2a and the head-mounted display 10_2b may include a display module which outputs a display image and a reflector which reflects the output display image and provides the reflected display image to the user’s eyes, thereby providing the user with a screen of virtual reality or augmented reality.

The smart watch 10_2c includes a biometric sensor as an input device, and may provide biometric information recognized by the biometric sensor to the user through a display module.

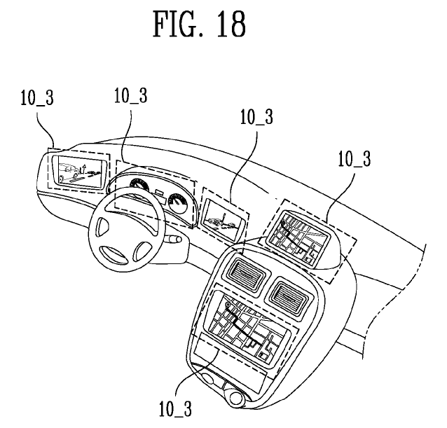

FIG. 18 illustrates a case where an electronic device including a display module is applied to a vehicle. For example, an electronic device 10_3 may be applied to an automotive dashboard, a center fascia or the like, or may be applied to a Center Information Display (CID) placed on a dashboard of a vehicle, a room mirror display replacing a side mirror, or the like.

The electronic device to which the display device according to the embodiments is applied may include not only devices, which mainly displays a screen, such as a digital billboard, an electric signboard, and a portable game machine, but also various home appliances, which display information through a display module, such as a refrigerator, a washing machine, a dryer, an air conditioner, and a robot vacuum cleaner. In addition, when the display module has a function of transmitting light, the display module may be applied to an electronic device such as a smart window or a transparent display device which displays a background and a display image together. Types of the electronic device, according to the embodiment, are not necessarily limited by the above-described examples, and various other electronic devices that are not illustrated may be applied.

A display device and an electronic device according to embodiments of the present disclosure may include a scan driver capable of reducing power consumption, among other benefits as described above.

While the present disclosure has been described with reference to embodiments thereof, it will be apparent to those of ordinary skill in the art that various changes and modifications may be made thereto without departing from the scope and spirit of the present disclosure.

What is claimed is:

1. A display device, comprising:
a pixel part including a plurality of pixel rows, each extending in a first direction, and each connected to an odd-numbered scan line and an even-numbered scan line; and
a scan driver including a plurality of scan stages, each connected to an odd-numbered scan line and an even-numbered scan line,
wherein each of the plurality of scan stages includes buffer transistors, and
wherein buffer clock lines connected to the buffer transistors extend in a second direction, crossing the first direction, between the buffer transistors and the pixel part.

2. The display device according to claim 1, wherein each of the plurality of scan stages comprises:
a logic circuit;
a first buffer transistor including a first electrode connected to an odd-numbered buffer clock line, a gate electrode connected to the logic circuit, and a second electrode connected to the respective odd-numbered scan line;
a second buffer transistor including a first electrode connected to the odd-numbered scan line and a gate electrode connected to the logic circuit;
a third buffer transistor including a first electrode connected to an even-numbered buffer clock line, a gate electrode connected to the logic circuit, and a second electrode connected to the respective even-numbered scan line; and
a fourth buffer transistor including a first electrode connected to the even-numbered scan line and a gate electrode connected to the logic circuit.

3. The display device according to claim 2, wherein the first buffer transistor is disposed on one side of the second buffer transistor, in the first direction, and
wherein the third buffer transistor is disposed on one side of the fourth buffer transistor, in the first direction.

4. The display device according to claim 3, wherein the logic circuit is disposed on one side of the first buffer transistor, the second buffer transistor, the third buffer transistor, and the fourth buffer transistor in a direction opposite to the first direction.

5. The display device according to claim 4, wherein the logic circuit is connected to a carry clock line, and
wherein the carry clock line is disposed on one side of the logic circuit in the direction opposite to the first direction and extends in the second direction.

6. The display device according to claim 4, wherein the logic circuit is connected to a carry clock line, and
wherein the carry clock line extends in the second direction between the first buffer transistor and the pixel part.

7. The display device according to claim 4, wherein the third buffer transistor is disposed on one side of the first buffer transistor, in the second direction, and
wherein the even-numbered scan line is disposed on one side of the odd-numbered scan line in the second direction.

8. The display device according to claim 7, wherein the fourth buffer transistor is disposed on one side of the second buffer transistor, in the second direction.

9. The display device according to claim 4, wherein the first buffer transistor is disposed on one side of the third buffer transistor, in the second direction, and
wherein the odd-numbered scan line is disposed on one side of the even-numbered scan line, in the second direction.

10. The display device according to claim 9, wherein the second buffer transistor is disposed on one side of the fourth buffer transistor, in the second direction.

11. An electronic device, comprising:
a processor providing grayscales of an image frame; and
a display device displaying an image using the provided grayscales of the image frame,
wherein the display device comprises:
a pixel part including a plurality of pixel rows, each extending in a first direction, and each connected to an odd-numbered scan line and an even-numbered scan line; and
a scan driver including a plurality of scan stages, each connected to an odd-numbered scan line and an even-numbered scan line,
wherein each of the plurality of scan stages includes buffer transistors, and
wherein buffer clock lines connected to the buffer transistors extend in a second direction, crossing the first direction, between the buffer transistors and the pixel part.

12. The electronic device according to claim 11, wherein each of the plurality of scan stages comprises:
a logic circuit;
a first buffer transistor including a first electrode connected to an odd-numbered buffer clock line, a gate electrode connected to the logic circuit, and a second electrode connected to the odd-numbered scan line;
a second buffer transistor having a first electrode connected to the odd-numbered scan line and a gate electrode connected to the logic circuit;
a third buffer transistor including a first electrode connected to an even-numbered buffer clock line, a gate electrode connected to the logic circuit, and a second electrode connected to the even-numbered scan line; and
a fourth buffer transistor including a first electrode connected to the even-numbered scan line and a gate electrode connected to the logic circuit.

13. The electronic device according to claim 12, wherein the first buffer transistor is disposed on one side of the second buffer transistor, in the first direction, and
wherein the third buffer transistor is disposed on one side of the fourth buffer transistor, in the first direction.

14. The electronic device according to claim 13, wherein the logic circuit is disposed on one side of the first buffer transistor, the second buffer transistor, the third buffer transistor, and the fourth buffer transistor in a direction opposite to the first direction.

15. The electronic device according to claim 14, wherein the logic circuit is connected to a carry clock line, and
wherein the carry clock line is disposed on one side of the logic circuit in the direction opposite to the first direction and extends in the second direction.

16. The electronic device according to claim 14, wherein the logic circuit is connected to a carry clock line, and
wherein the carry clock line extends in the second direction between the first buffer transistor and the pixel part.

17. The electronic device according to claim 14, wherein the third buffer transistor is disposed on one side of the first buffer transistor, in the second direction, and
wherein the even-numbered scan line is disposed on one side of the odd-numbered scan line.

18. The electronic device according to claim 17, wherein the fourth buffer transistor is disposed on one side of the second buffer transistor, in the second direction.

19. The electronic device according to claim 14, wherein the first buffer transistor is disposed on one side of the third buffer transistor, in the second direction, and
wherein the odd-numbered scan line is disposed on one side of the even-numbered scan line, in the second direction.

20. The electronic device according to claim 19, wherein the second buffer transistor is disposed on one side of the fourth buffer transistor, in the second direction.
